(19) United States
(12) Patent Application Publication
(10) Pub. No.: US 2014/0150661 A1
(43) Pub. Date: Jun. 5, 2014

(54) Device for Absorbing Vapours from a Fuel Tank

(71) Applicant: Timo Himmel, Nufringen (DE)

(72) Inventor: Timo Himmel, Nufringen (DE)

(73) Assignee: Daimler AG, Stuttgart (DE)

(21) Appl. No.: 14/118,133

(22) PCT Filed: Nov. 30, 2011
(86) PCT No.: PCT/EP2011/006004

§ 371 Date: Feb. 7, 2014

(30) Foreign Application Priority Data
May 17, 2011 (DE) 10 2011 101 657.4

(51) Int. Cl. F02M 25/08

(52) U.S. Cl. CPC F02M 25/0836; F02M 25/0854
USPC 96/133; 96/108; 137/627

(57) ABSTRACT

A device for binding vapors from a fuel tank includes a storage element for the vapors. The storage element includes one or two storage areas. The device has a cover designed to close the storage element. The cover has at least two valve devices, each of which has valve bodies and valve seats. The valve seats, which are designed for receiving the valve bodies in such a way that they can be moved, are integrated in the cover.

The invention relates to a device for binding vapors from a fuel tank according to the genre that is defined more precisely in the preamble of claim 1.

In order to operate motor vehicles that use volatile fuels to run their internal combustion engines, it will be necessary in the future to control reliably the evaporative and refueling emissions, as a function of the specific market needs and the legal requirements.

For example, in one embodiment that permits an improved method for testing the system, a separation of the storage device for the refueling emissions and for the evaporative emissions is provided. Such a tank system is disclosed, for example, in U.S. Pat. No. 5,111,795. In this conventional tank system with tank ventilation, the fuel tank has two vent lines for the refueling emissions ORVR (onboard refueling vapor recovery) and for the evaporative emissions EVAP (evaporative emission) respectively. In this case these two vent lines merge at a multiway valve, from which two additional lines run to a first storage arrangement and a second storage arrangement respectively for absorbing the hydrocarbons from the volatile fuel vapors. Depending on the operating situation, the multiway valve is controlled in such a way that the refueling emissions are conveyed to the one storage device, or the evaporative emissions are conveyed to the other storage device. Both storage arrangements are connected by means of separate purge lines to an intake tract of the internal combustion engine.

In order to operate motor vehicles that use volatile fuels to run their internal combustion engines, it will also be necessary in the future to test the tank system of the motor vehicle for leaks on a regular basis with built-in means (onboard diagnostics, OBD). In this case the control systems have to have the capability of detecting reliably a leak, even in an order of magnitude of 0.5 mm diameter. At the same time the new government regulations, in particular those in the U.S., require a separate leak test in the different subchambers of the tank system, at least for specific types of motor vehicles, such as hybrid vehicles.

A tank system designed in such a fashion with two storage areas, i.e. one storage area for receiving fuel vapors during the refueling operation of the fuel tank and one storage area for receiving the fuel vapors during normal operation of the vehicle, is also known from DE 10 2009 040 680 A1. This system describes the exact design of the type of tank system that is prescribed for use, for example, in the U.S. In countries, in which the tank emissions are extracted by means of the fuel pump nozzle during refueling, the use of the second storage area is not mandatory. Therefore, this second storage area can be dispensed with. In the final analysis, the result is a comparatively expensive system, despite the integration of components described in said German patent application, because the system has components that differ from country to country and, hence, have to be produced in comparatively small production runs. This feature constitutes a significant drawback.

The German patent application DE 10 2009 036 265 A1 also discloses such a tank system that makes it possible to test specifically for the presence of a leak in any one of the various subchambers of the tank system.

Furthermore, there is basically the desire or rather the need in the field of automotive engineering to use designs that are as compact as possible and that reduce the amount of installation space to a minimum. It goes without saying that this objective also applies to the tank system of a motor vehicle.

At this point the object of the present invention is to avoid the above-described drawbacks and to provide a device that is designed for binding vapors from a fuel tank and that can be produced in a modularized fashion with largely standardized components in such a way that this device can be adapted easily and efficiently to the conditions of particular countries.

The invention achieves this engineering object by means of the features disclosed in the characterizing part of claim 1. Additional advantageous designs of the invention are disclosed in the other dependent claims that are dependent on claim 1.

The invention provides that the storage element comprises one storage area or two storage areas in order to be able to implement the EVAP system or the EVAP and ORVR system in compliance with the country-specific specifications. The storage element is closed by means of the one cover that is formed so as to be identical independently of the number of storage areas; and this one cover has at least two valve devices with a valve body and a valve seat. In this case the cover comprises in an integrated manner the valve seats for receiving the valve bodies in such a way that they can be moved; and said cover is identical independently of the country-specific design of the overall structure. This arrangement makes it possible to use a single cover for any and all types of the device and at the same time allows, analogous to a modular building block system, a significant increase in the quantity and, thus, a substantial reduction in both the cost of the cover and even the cost of the connecting elements, which are connected to the valve devices of the cover, for example, for connecting the device to the surrounding area and to the tank.

Moreover, the valve bodies, which are inserted into the cover, can be designed to meet the requirements of specific countries, so that said valve bodies exhibit a number of control ports that are connected to each other in the interior of the valve body; and this number of control ports is larger by the number 1 than the number of storage areas. Therefore, given the fact that the cover is formed in an identical manner, the valve bodies are chosen in such a way that the country-specific configuration of the cover can be implemented easily and efficiently.

It goes without saying that it is also possible, as an alternative, to construct the cover with the valve seats and also the valve bodies with the maximum number of control ports in such a way that said cover is always identical in all country-specific variants.

In this respect an especially advantageous further development provides that the port of the first valve device is connected to the tank, to the first storage area, if present to the second storage area, or, if this second storage area is not present, to the first storage area or to a functionless area of the storage element. Similarly a comparable arrangement can also apply to the second valve device, which realizes the connection to the surrounding area. The configuration allows the cover to be used with a storage element that has only one storage area. This storage area can then fit, for example, in size, to the cover and can fill the entire surface area of the storage element. Then the result is a connection of the first storage area by means of one or two of the ports, depending on the design of the valve bodies. In an alternative embodiment it can be provided that the storage element comprises two adjacent storage areas, each of which interacts with one of the control ports of the valve device. Then a targeted switching of the connection to the first, the second or the two storage areas is possible. The design can be modified to meet country-specific requirements in such a way that the second storage area is not filled with a storage medium and, as a result, remains as a functionless area inside the storage element.

In addition to the above-described configuration of the cover, it goes without saying that this cover can have additional functional elements, for example, connections for extracting fuel vapors in the area of an internal combustion engine or any other type of combustion system, and safety devices, such as pressure relief valves or the like. Since these functional elements are usually not designed to meet country-specific requirements and are present, as required, both during the use of one storage area and also during the use of two storage areas, they are not further relevant for the description of the present invention. However, they can also be integrated in the cover in an identical manner for any and all designs.

Additional advantageous embodiments of the device according to the invention will be apparent from the rest of the dependent claims and are clearly described by means of the exemplary embodiment that is described in detail below with reference to the figures.

The drawings show in:

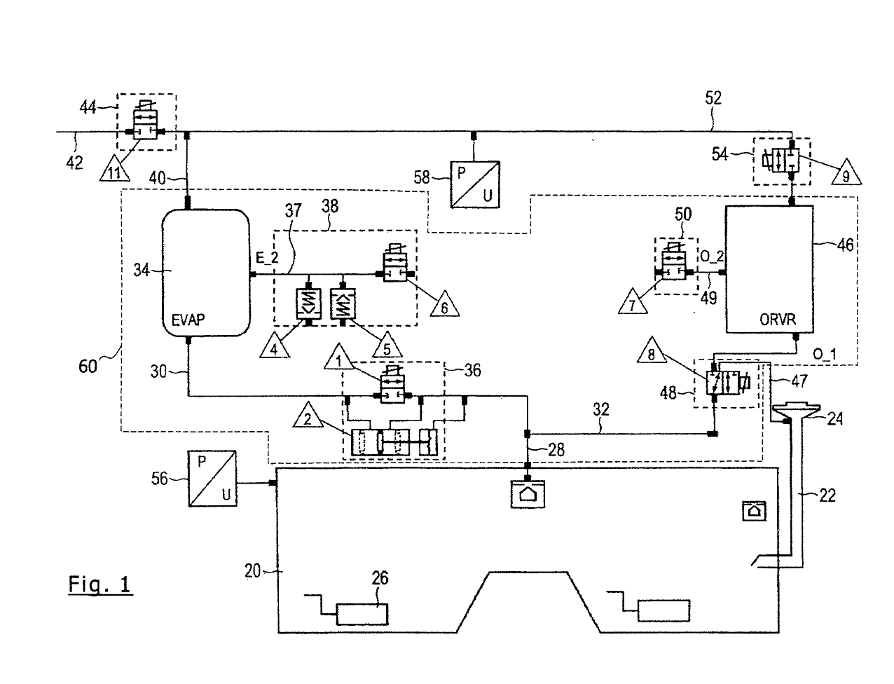

FIG. 1 a tank system for illustrating the basic design of a device, according to the invention, in a tank system;

FIG. 2 a first embodiment of the inventive device by means of a schematic diagram;

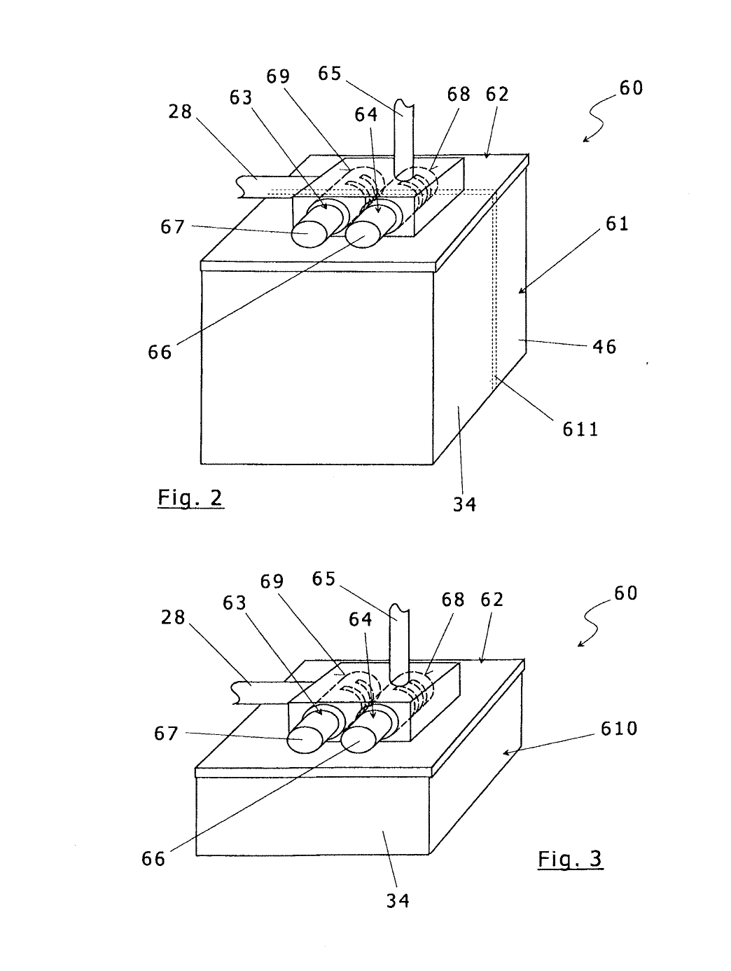

FIG. 3 a second embodiment of the inventive device by means of a schematic diagram;

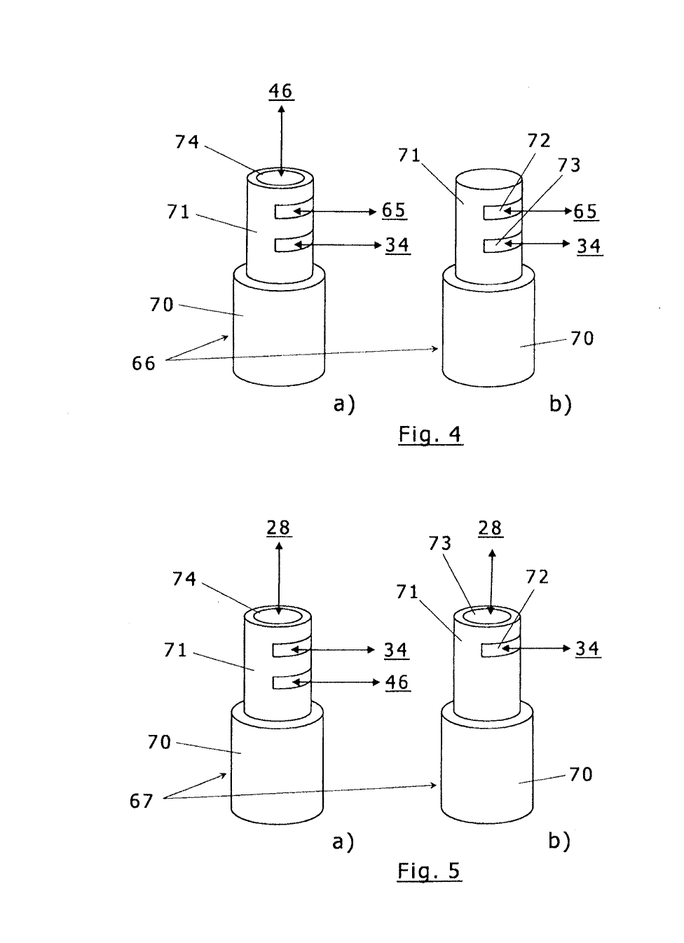

FIG. 4 a first possible embodiment of the valve seats in two country-specific versions; and

FIG. 5 a second possible embodiment of the valve seats in two country-specific versions.

First of all, at this point the basic design of a device 60 according to the present invention shall be explained in detail with reference to FIG. 1, using the example of a tank system for a motor vehicle. It should be noted that the invention can also be used in the same manner in tank systems of other applications.

The tank system of the motor vehicle comprises a fuel tank or more specifically the tank 20 for receiving a volatile fuel (gasoline, diesel, etc.). The fuel can be filled into the tank 20 by way of a fuel tank filler neck 22; and said tank can be closed with a tank cap 24. A tank cap sensor (not depicted) detects whether the tank cap 24 is open or closed.

The fuel is supplied by means of one or more fuel pumps 26 from the tank 20 through a fuel feed line to at least one injection valve. These injection valves empty in the conventional manner, for example, downstream of a throttle flap into an intake tract of the internal combustion engine. However, depending on the type of internal combustion engine, the injection valves can also empty at any other point into the intake tract or directly into the internal combustion engine. Moreover, it is not absolutely mandatory that the fuel feed line has to convey the fuel from the tank 20 to an injection valve. Depending on the type of internal combustion engine and the type of fuel, other numbers, variants and arrangements are also possible in this case, too.

Furthermore, the tank 20 is provided with a vent line 28, through which the fuel vapors, which are generated during a refueling operation of the tank 20 or during normal operation of the internal combustion engine, can be removed from the tank 20. This vent line 28 bifurcates into a first vent branch line 30 and a second vent branch line 32. The vent line 28 and the first vent branch line 30 form the first vent line; and the vent line 28 and the second vent branch line 32 form the second vent line.

The first vent line 28, 30 runs to a first storage device 34, in which the fuel vapors, or more specifically the hydrocarbons in the volatile fuel vapors, from the tank 20 are bound at least intermittently. The first storage device 34 can be designed, for example, as one or more activated charcoal canisters for reversibly binding the volatile hydrocarbons. This first storage device 34 is used to receive the evaporative emissions from the fuel (EVAP) while the internal combustion engine is running.

A first tank shut-off valve 36 is arranged in the first vent branch line 30. In the example from FIG. 1 this first tank shut-off valve 36 is formed by two valve elements 1 and 2. In addition, the first tank shut-off valve 36 is preferably a valve that is closed in the de-energized state, so that no continuous slow feed of evaporative emissions into the first storage device 34 can take place. This would be especially disadvantageous, in a situation, in which the first storage device 34 had no more holding capacity; and, therefore, it could result, for example, in a breakthrough of the activated charcoal canister(s). In addition, the tank can be held under moderate pressure.

The first storage device 34 is connected to the atmosphere by means of a first aeration line 37. A first aeration valve 38 is provided in or on this first aeration line 37 and comprises three valve elements 4, 5, 6 in the example from FIG. 1.

In addition, the first storage device 34 is connected downstream of the throttle flap to the intake tract of the internal combustion engine by means of a first purge branch line 40 and a purge line 42 on the downstream side of said first storage device. A first regenerating valve 44 is arranged in or on this purge line 42 and comprises only one valve element 11 in the example from FIG. 1. The second vent line 28, 32 extends in an analogous manner to a second storage device 46, in which the fuel vapors from the tank 20 can be bound at least intermittently. The second storage device 46 can also be formed, for example, as one or more activated charcoal canisters for reversibly binding the volatile hydrocarbons. This second storage device 46 is used to receive the refueling emissions of the fuel (ORVR) during a refueling operation of the tank 20 by means of a fuel tank filler neck 22.

A second tank shut-off valve 48 is arranged in the second vent branch line 32. This second tank shut-off valve 48 is, analogous to the first tank shut-off valve 36, preferably also a valve that is closed in the de-energized state, so that no continuous slow feed of evaporative emissions into the second storage device 46 can take place. However, the second tank shut-off valve 48 in the example from FIG. 1 is formed by only one valve element 8.

In addition, there is a third vent branch line 47, which extends directly from the fuel tank filler neck 22 over the second tank shut-off valve 48 into the second vent branch line 32 and further into the second storage device 46. The line 47 is intended to show a non-existing tank cap.

Furthermore, the second storage device 46 is connected to the atmosphere by means of a second aeration line 49. A second aeration valve 50 is provided in or on this second aeration line 49 and comprises only the one valve element 7 in the example from FIG. 1.

In addition, the second storage device 46 is also connected downstream of the throttle flap to the intake tract of the internal combustion engine by means of a second purge branch line 52 and the purge line 42 on the downstream side of said second storage device. A second regenerating valve 54 is arranged in or on this second purge branch line 52 and is formed by only one valve element 9 in the example from FIG. 1. However, this arrangement is not absolutely mandatory. Furthermore, the tank system, depicted in FIG. 1, has a first pressure sensor 56 and a second pressure sensor 58.

The first pressure sensor 56 is arranged, for example, on the tank 20 and/or the vent line 28, in order to detect a pressure level in the tank system. The second pressure sensor 58 is arranged, for example, on the second purge branch line 58, in order to detect a pressure level in the tank system. The two pressure sensors 56, 58 are coupled preferably to a control system (not illustrated).

The tank system from FIG. 1 can be subdivided into a number of subchambers by means of the existing valves, in order to be able to conduct specific seal tightness tests or more specifically leak tests. As stated above, these leak tests are described in detail in the German patent application no. 10 2009 036 265, which has not been published yet and which is hereby incorporated by reference in its entirety.

The device 60 for binding vapors from the fuel tank is shown by way of example in the following figures. In this case said device combines the storage device 34 or the storage device 34 and the storage device 46, as two separate storage areas, into one storage element 61 in such a way that said device meets the country-specific requirements.

The device 60 of the invention is not restricted to the tank system, shown in FIG. 1. Rather a number of modifications or more specifically variants of the tank system are conceivable, to which the invention can also be applied in an advantageous way.

For example, when modifying the tank system from FIG. 1, it is possible to dispense with the vent line 28. In this case the first vent branch line 30 to the first storage device 34 and the second vent branch line 32 to the second storage device 46 are then connected directly to the interior of the tank 20.

Furthermore, there is also the possibility that the first and the second purge branch line 40, 52 from the two storage devices 34, 46 are connected separately from each other to the intake tract of the internal combustion engine. In other words, the second purge branch line 52 does not empty into the purge line 42 from FIG. 1. In this case the second pressure sensor 58 can be assigned, for example, to the two purge branch lines 40, 52; or, as an alternative, two second pressure sensors 58 can be provided for one of the two purge branch lines 40, 52 respectively.

The drawing from FIG. 2 shows an exemplary model of the device 60. The device 60 consists in essence of a cover 62 and the storage element 61, which is closed by this cover. In the exemplary embodiment shown in FIG. 3, the storage element 61 comprises two storage areas 34, 46, which are separated from each other by a partition 611. These storage areas correspond to the above-described first storage device 34 (EVAP) and the above-described second storage device 46 (ORVR). The purge branch lines 40, 52 are not shown herein, in order to simplify the design. The two valve devices 63, 64 are arranged in the cover 62 in such a way that they are structurally integrated. In the design according to the invention, the vent branch lines, which are marked with the reference numerals 30, 32 in the drawing from FIG. 1, are combined into a single vent line, which in turn is provided with the reference numeral 28 in analogy to the drawing from FIG. 1. A comparable arrangement applies to the aeration lines 37 and 49. In the drawing from FIG. 3 these aeration lines are designed as a combined aeration line and provided with the reference numeral 65. The two purge branch lines 40, 52 from FIG. 1 can exist separately in the cover 62, as described above. However, these two purge branch lines are also already combined in the interior of the cover 62 in an especially practical way so that there is a common connection for a purge line (not illustrated) in the area of the cover 62.

Each of the two valve devices 63, 64 consists of a valve body 66, 67 and a valve seat 68, 69 that is formed in the cover 62. In this case the valve seats 68, 69 are designed in such a way that they have ports (not visible herein), so that the valve seat 69 of the first valve device 63 is connected to the vent line 28 and thereby to the tank 20 and, in addition, by way of additional ports to the first storage area 34 and the second storage area 46. Therefore, the first valve device 63 controls the connection between the tank 20 and the storage areas 34, 46. The valve device 63 is also called FTIV (fuel tank isolation valve). The second valve device 64 is constructed in a comparable manner and connects the aeration line 65 as one of the ports of its valve seat 68 to both the first storage area 34 and to the second storage area 46. The valve device 64 is also called AIV (air isolation valve).

At this point the design of the device 60, shown in FIG. 2, controls by means of its two valve devices 63, 64 (the valve bodies 67, 66 of which will be described in detail below) both the loading of the first storage area 34 and also the second storage area 46 with fuel vapors in the above-described respective situations. Therefore, the cover 62 can be used especially in such systems that require both the first and the second storage area. In order to be able to minimize the number of mandatory components, it can now be provided that the identical design of the device 60, as shown in FIG. 2, is used in such a way that it has only the first storage area 34, whereas the second storage area 46 is not filled with a storage medium. This arrangement makes it possible to create easily and efficiently a device 60 for such markets, in which refueling vapors are extracted by the refueling system itself, as is the case, for example, in the European Union.

As an alternative, it is possible to conceive of the design, shown in FIG. 3. Instead of the comparatively high storage element 61, said design in FIG. 3 uses a storage element 610 that has only the first storage area 34 for holding the fuels, generated during normal operation, over the cross sectional area of the storage element 61. In this case, too, the cover 62 with the integrated valve seats 68, 69 can remain unmodified.

In principle, the use of identical valve bodies 66, 67 is conceivable and possible in all of the design variants. However, the valve bodies 66, 67 can be modified in a very simple way without adversely affecting the principle of the cover 62 that can be used in a modular fashion for a wide range of country-specific devices 60. The drawings in FIGS. 4 and 5 show some examples of the valve bodies 66, 67 for various design variants.

FIG. 4 shows the valve body 66 of the valve device 64. The design variant for two storage areas 34, 46 is located on the left-hand side in FIG. 4a, whereas the drawing in FIG. 4b shows a possible design variant using only the first storage area 34. The design of the valve device comprises not only an actuator area 70 but also a tubular area 71 with control ports 72 and 73, which are configured in the form of slots, which extend partially around the periphery and are connected to each other in the interior of the valve body 66. In addition, the drawing from FIG. 4a shows a third control port 74. This control port 74 is implemented in the form of an open end face of the tubular area 71 and is connected to the control ports 72 and 73 in the interior of the tubular area 71. The third control port 74 is missing in the version, depicted in FIG. 4b. At this point the situation is such that, analogous to the drawings in FIGS. 2 and 3, the valve body 66 can be connected, as indicated in schematic form, to the aeration line 65 in the area of a first control port 72. The second control port 73 can be connected to the first storage area 34 for receiving the fuel vapors generated during normal operation. The third control port 74 can be connected, if present, to the second storage area 46. Depending on the rotational position of the valve body 66, the surrounding area 65 of the device 60 can be connected, for example, as shown in the drawing from FIG. 4a, either to the first storage area 34, to the second storage area 46 or to both storage areas 34, 46. In addition, it is conceivable to block completely the connection between both the storage areas 34, 46 as well as to the aeration line 65. The variant, depicted in FIG. 4b and used for other country-specific embodiments, dispenses only with the third control port 74. As a result, the aeration line 65 can be connected to the single storage area 34 or can be separated from the same.

In principle, the valve bodies 67 of the valve device 63 are configured in a comparable fashion and connect selectively either the first storage area 34, the second storage area 46 or both storage areas 34, 46 to the vent line 28 or shut off said vent line.

The drawing from FIG. 5 shows an alternative embodiment, using the valve body 67 as an example. This alternative embodiment of the valve body as well as the valve body 66 can be used in the manner described above. Consequently the methodology of the drawing corresponds in essence to the one used in FIG. 4. Hence, FIG. 5a shows in turn the variant with the three control ports 72, 73, 74, analogous to the drawing in FIG. 4a. Since, however, the valve body 67 of the first valve device 63 is described here, the connection is established in such a manner that the first control port 71 in turn is formed as a slot that extends partially around the periphery and can be connected to the vent line 28. This time the open end face of the tubular portion 71 is configured as the second control port 73 and can be connected to the first storage area 34. The drawing from FIG. 5a shows clearly that the valve body 67 has a second slot as the third control port 74, which in turn can be connected to the second storage area 46. The embodiment of the valve body 67, depicted in FIG. 5b and provided for use without the second storage area 46, dispenses with this third control port.

At the same time it is clear to the person skilled in the art from the exemplary drawings from FIGS. 4 and 5 that the allocation of individual ports to the individual areas 28, 65, 34, 46 can be approximately random and that the above-described variants are to be understood as only exemplary embodiments.

1-10. (canceled)

11. A device configured to bind vapors from a fuel tank, the device comprising:
a storage element configured to hold the vapors, wherein the storage element comprising one storage area or two storage areas; and
a cover structurally configured to close the storage element, wherein the cover includes at least two valve devices, each of which comprises valve bodies and valve seats,
wherein the valve seats, which are structurally configured to receive the valve bodies in such a way that they can be moved, are integrated in the cover,
wherein each of the valve bodies includes a number of control ports that are connected to each other in an interior of the valve body, and
wherein the number of control ports is larger by the number 1 than the number of storage areas.

12. The device of claim 11, wherein each of the valve seats has, independently of whether there are one or two storage areas, three ports, corresponding with the number of control ports, to the extent that these control ports are present.

13. The device of claim 12, wherein the ports of the first valve device are connected to
the fuel tank, the first storage area, and the second storage area if the second storage area is present, or
the fuel tank and either the first storage area or a functionless area of the storage element if the second storage area is not present.

14. The device of claim 12, wherein the ports of the second valve device are connected to
a surrounding area, the first storage area, and the second storage area if the second storage area is present, or
the surrounding area and either the first storage area or a functionless area of the storage element if the second storage area is not present.

15. The device of claim 11, wherein the storage element has two storage areas, and wherein, according to a country-specific feature of the device, only the first storage area or both storage areas is and/or are filled with an activated charcoal storage medium.

16. The device of claim 11, wherein
the valve bodies are essentially tubular, wherein a first control port is a slot extending in circumferential direction partially around a periphery; and
a second control port is an additional slot extending in the circumferential direction partially around the periphery or is an end face that is open in the axial direction of the valve body.

17. The device of claim 16, wherein a third control port is formed
complementary to the second control port as an end face, which is open in a axial direction, or
as a slot extending in the circumferential direction partially around the periphery.

18. The device of claim 11, wherein the valve seats and the ports are integrated with the cover.

19. The device of claim 11, wherein the cover comprises, in addition to the two valve devices, additional connecting elements or valve devices.
